(19) United States
(12) Patent Application Publication
(10) Pub. No.: US 2017/0056827 A1
(43) Pub. Date: Mar. 2, 2017

(54) MEMBRANE SEPARATION UNIT INCLUDING ENHANCED SEALING RING

(71) Applicant: LG NANOH2O, INC., El Segundo, CA (US)

(72) Inventor: Roberto Castellanos, Torrance, CA (US)

(73) Assignee: LG NANOH2O, INC.

(21) Appl. No.: 14/836,745

(22) Filed: Aug. 26, 2015

(51) Int. Cl. B01D 63/12; F16J 15/3284; B01D 63/10

(52) U.S. Cl. CPC B01D 63/12; B01D 63/10; F16J 15/3284; B01D 2313/04; B01D 2313/16

(57) ABSTRACT

Disclosed are a membrane separation unit including an enhanced sealing ring and a membrane separation unit including an enhanced sealing ring, which is more easily detachable as a top cross-section of a sealing ring is symmetrically formed.

### TECHNICAL FIELD

The present invention relates to a membrane separation unit including an enhanced sealing ring, and to a membrane separation unit including an enhanced sealing ring, which is more easily detachable as a top cross-section of a sealing ring is symmetrically formed.

The present invention relates to, for example, a system and a technology that improve a seal in a membrane separation device between a membrane separation device housing holding one or more spiral membrane units and a spiral membrane unit.

### BACKGROUND ART

Membrane separation devices can be used in various fields. In some cases, the membrane separation devices can be used to purify water. For example, seawater can be purified in a membrane separation device that uses reverse osmosis in order to provide drinking water. In waste water treatment, the membrane separation device may be used to remove high molecules, colloid, and particles for sterilizing waste water.

The membrane separation device can include one or more spiral membrane units. The spiral membrane configuration is often used so that a flat sheet membrane can be efficiently packaged in a small space. The spiral membrane configuration can be packaged in a cartridge so as to form the spiral membrane units. The spiral membrane units are typically loaded on a cylindrical device housing. Since the cylindrical device housing can be momentous with respect to a separation process in which high pressure is efficient, the cylindrical device housing can receive pressure applied to the units, which passes through the spiral membrane units.

### SUMMARY OF THE INVENTION

The present invention relates to an enhanced sealing ring and the sealing ring serves to make strong coupling between a membrane separation unit and a housing. When the sealing ring is not provided, components cannot effectively perform functions thereof.

However, a sealing ring disclosed in Korean Patent Unexamined Publication No. 10-2014-0068053 in the related art shows a sufficient function as a sealing member, but is slightly difficult to couple to and remove from the housing due to an asymmetric design.

The present invention is proposed to overcome such a disadvantage.

The present patent describes a sealing system which can be used a membrane separation device, a sea plate, and a sealing ring.

The sealing system according to the present invention may reduce a pressure difference between different zones of the membrane separation device while continuously providing strong seal between a device housing holding multiple membrane separation unit and the membrane separation units. Further, the membrane separation units provided in the present invention may be inserted in or removed from both a fluid flowing direction and an opposite direction thereto. The sealing system provided in the present invention may also permit a fluid to flow in a normal fluid flowing direction or a reverse direction thereto.

An exemplary embodiment of the present invention provides a membrane separation unit which may include at least one membrane disposed in a cartridge, at least one seal plate, and a sealing ring seated on an outer groove of the seal plate. Herein, the cartridge may include an interior, an exterior, and a pair of ends. Herein, the seal plate may seal one end of the cartridge.

In particular, a top cross-section of the sealing ring may be symmetrically formed. A cross-section of the sealing ring may include a rounded interior surface and two flat lateral surfaces. The cross-section of the sealing ring may include two flat surfaces that meet at a tip along an external surface of the sealing ring and two flat surfaces may be symmetric to each other.

The sealing ring may have a cross-sectional shape in which a circular venting path is formed between the sealing ring and the seal plate. The seal plate may include at least one ventilation hole, and the ventilation hole may form a passageway between the outer groove and the interior of the cartridge.

Details of one or more exemplary embodiments are described below with the accompanying drawings. Various features and advantages can clearly be found from the Detailed Description, the drawings, and the Claims.

According to an exemplary embodiment of the present invention, a top cross-section of a sealing ring is symmetrically formed to maintain strong coupling between a membrane separation unit and a housing and moreover, the sealing ring can be more easily installed in and removed from a container.

By the design of the sealing ring according to the present invention, the sealing ring can be applied even to a seal plate using U-cup sealing which is an industrial standard.

### BRIEF DESCRIPTION OF THE DRAWINGS

FIG. 1 is a diagram of an example illustrating how spiral membrane units can be positioned in a cylindrical device housing.

FIGS. 2A, 2B, and 2C are a front view, a bottom view, and a cross-sectional view of a sealing ring 28 according to the present invention.

FIG. 3 is a cross-sectional view illustrating a situation in which the sealing ring 28 is seated on a seal plate 10 according to the present invention.

FIG. 4 is a perspective view of a front portion of the seal plate 10 according to the present invention.

FIG. 5 is a perspective view of a bottom portion of the seal plate 10 according to the present invention.

### DETAILED DESCRIPTION

Hereinafter, a preferred embodiment of a membrane separation unit including an enhanced sealing ring according to an exemplary embodiment of the present invention will be described with reference to the drawings. In the process, thicknesses of lines or a size of a constituent element illustrated in the drawing, and the like, may be exaggerated for clarity and ease of description. Further, the terms used in the description are defined considering the functions of the present invention and may vary depending on the intention or usual practice of a user or operator. Accordingly, the terminology needs to be defined base on details throughout this specification.

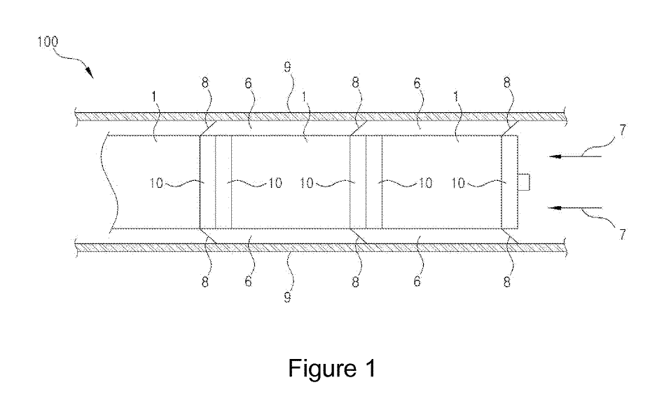

FIG. 1 is a diagram of an example illustrating how spiral membrane units can be positioned in a cylindrical device housing.

A spiral membrane configuration may be used for packaging flat sheet membranes into a space efficient configuration for use in membrane separation devices. A spiral membrane configuration may be included in a membrane separation unit that includes the spirally configured separation membrane within a cartridge. Seal plates may be attached at opposite ends of the cartridge to form the membrane separation unit. The seal plates may include passageways to guide a fluid flow through a spiral membrane within the cartridge and to collect fluid that passes through the spiral membrane. Each spiral membrane unit may be loaded into and removed from a cylindrical device housing of a membrane separation device.

As illustrated in FIG. 1, a pressurized feed flow 7 is introduced into the end of the device housing 9 of a membrane separation device 100. A plurality of sealing rings 8 seated in the sealing plates 10 directs the feed flow 7 into spiral element flow channel(s) and prevents fluid from flowing into an annular space 6 between a cylinder wall of the device housing 9 and the membrane separation unit 1.

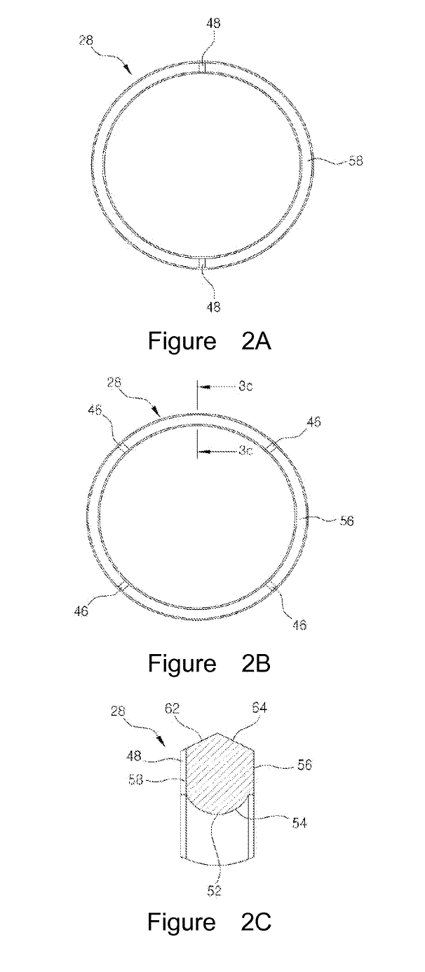

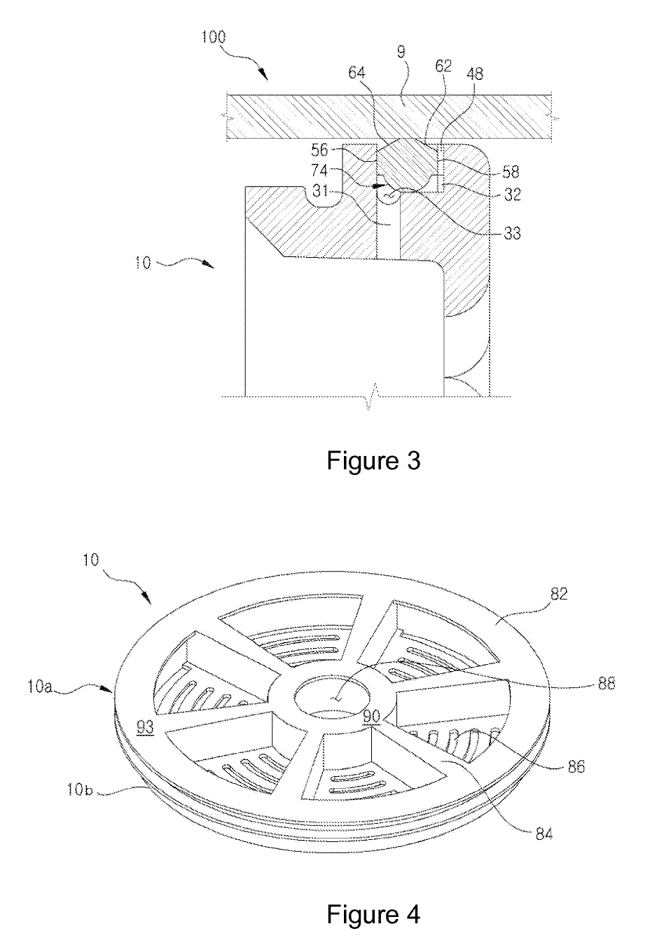

FIGS. 2A, 2B, and 2C are a front view, a bottom view, and a cross-sectional view of a sealing ring 28 according to the present invention. FIG. 3 is a cross-sectional view illustrating a state in which the sealing ring 28 is seated on a seal plate 10 according to the present invention.

As provided in the present invention, the sealing rings 28 and the seal plates 10 may be used in the membrane separation device 100. The sealing rings 28 provided in the present invention may allow the spiral membrane units to be moved within the cylindrical device housing 9 of the membrane separation device in any one direction. The sealing rings 28 and the seal plates 10 provided in the present invention also allow a reverse fluid flow of fluid through the spiral membrane configuration, which may be useful during maintenance and/or cleaning operations.

The seal plate 10 may include one or more outer grooves 32. The outer grooves 32 are positioned to be adjacent to an inside surface of the device housing 9. In this case, the sealing ring 28 may be positioned within the outer groove 32 to provide a seal (that is, sealing) between the membrane separation unit 1 and the cylindrical device housing 9 of the membrane separation device 100.

The sealing ring 28 according to the exemplary embodiment of the present invention may have a circular shape. Further, the inside surface of the sealing ring 28 may include rounded bottom portions 52 and 54, similar to a conventional o-ring and a front face 58 and a rear face 56 the sealing ring 28 may have a flat cross-sectional shape (that is, two flat lateral surfaces).

The front face 58 and the rear face 56 of the sealing ring 28 may maintain contact with the walls of the outer groove 32 of the seal plate 10. The front and rear faces 58 and 56 may prevent rotation of the sealing ring 28 within the outer groove 32 of the seal plate 10, especially during insertion of the membrane separation unit 1 into the membrane separation device 100 or movement of the membrane separation unit 1 in any one direction.

As illustrated in FIGS. 2A and 2B, the front face 58 of the sealing ring 28 may include two front-face grooves 48 and the rear face 56 of the sealing ring 28 may include four rear-face grooves 46. In some cases, it is noted that the front and/or rear faces may have any suitable number of grooves.

As illustrated in FIG. 2C, a top cross-sectional portion of the sealing ring 28 according to the present invention may be symmetrically formed. That is, the sealing ring 28 may include two flat surfaces 62 and 64 that meet at a tip along an upper outer surface of the sealing ring and the two flat surfaces 62 and 64 may be symmetric to each other. The upper surfaces 62 and 64 of the sealing ring 28 rise to a point to minimize the drag force of the seal in contact with a cylinder wall of the device housing 9. By such a configuration, strong coupling may be maintained between the membrane separation unit 1 and the device housing 9 and moreover, the sealing ring may be more easily installed in and removed from a container.

In some cases, the sealing ring 28 may have a diameter between 0.5 inch and 100 inches, between 1 inch and 50 inches, between 2 inches and 25 inches, between 4 inches and 15 inches, or between 6 inches and 10 inches. For example, the sealing ring 28 may have a diameter of about 2, 2.5, 4, 8, or 16 inches. In a cross-section, the sealing ring 28 may have a height between 0.1 inch and 1.0 inch, between 0.2 inches and 0.5 inches, or between 0.25 inches and 0.30 inches. Further, in the cross-section, the sealing ring 28 may have a thickness between 0.1 inch and 1.0 inch, between 0.2 inches and 0.5 inches, or between 0.25 inches and 0.30 inches. For example, the sealing ring 28 may have a thickness of about 0.27 inches and a height of about 0.27 inches.

As illustrated in FIG. 3, one or more radial holes (that is, ventilation holes) may be formed in the seal plate 10. The radial holes 31 may provide a fluid flowing passageway that allows an internal space in the membrane separation unit 1 and the outer groove 32 to be in communication with each other. The radial holes 31 may allow the fluid to pass through the external groove 32. As a result, the fluid may flow to an outer annular space through a rear-face groove 46, which may have enable pressure between the annular space and the membrane separation unit 1 to be equalized.

The sealing ring 28 and the seal plate 10 may provide a circular venting path 74 behind the peripheral seal of the sealing ring 28. To this end, the sealing ring 28 has a cross-sectional shape in which the circular venting path is formed between the sealing ring 28 and the seal plate 10. As illustrated in FIG. 3, the circular venting path 74 may be formed between the rounded inside surface of the sealing ring 28 and the outer groove 32 of the seal plate 10. The circular venting path 74 may allow fluid communication between respective rear-face grooves 46 and/or between respective radial holes 31. In some cases, the circular venting path 74 may be achieved by providing grooves, the sealing ring 28 and/or a grooved depression 33 in the inside surface at the back edge of the outer groove 32 of the seal plate. In some cases, the circular venting path 74 may be the result of the outer groove 32 having a more rectangular cross-section than the inside surface of the sealing ring 28.

The circular venting path 74 may communicate with the inside of the membrane separation unit 1 via one or more radial holes 31 in the seal plate 10 to allow the pressure to be balanced between different internal sections of the membrane separation unit 1.

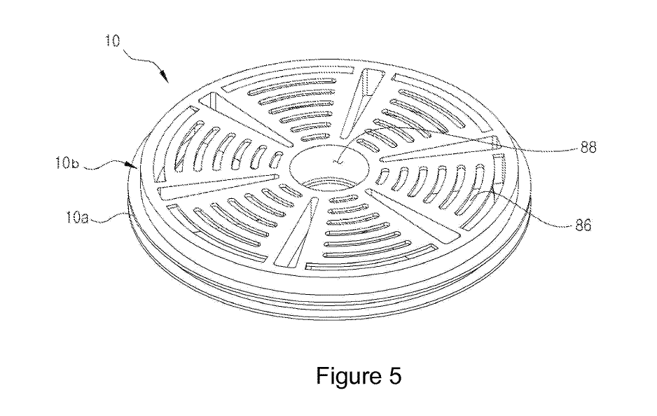

FIG. 4 is a perspective view of a front portion of the seal plate 10 according to the present invention. FIG. 5 is a perspective view of a bottom portion of the seal plate 10 according to the present invention.

Referring to FIGS. 4 and 5, the seal plate 10 according to the present invention may include a body part which at least two concentric passages penetrate and a disk part including a plurality of holes 86 and a central passageway.

In detail, the body part may include an outer ring 93 and a central ring 90, a plurality of spokes 84 connecting both rings, and gripping lips 82 and a first passageway 88 is formed by the center ring 90 and a second passageway is formed between the center ring 90 and the outer ring 93, in two concentric passages. In addition, the outer ring 93 may include an outer groove adopted to hold the sealing ring 28. Further, the disk part is formed to include the plurality of holes 86 and the central passageway. Herein, the disk part is provided on a rear face of the body part in an integrated form. The central passageway of the disk part is aligned with a first passageway 88 of the body part and the plurality of holes 86 is aligned with a second passage.

The seal plate 10 may include the gripping lips 82 that may be used as gripping points for pulling the membrane separation unit 1 to the outside of the device housing 9. The gripping lips 82 may be provided in the outer ring 93 of the body part. The plurality of holes 86 is provided to allow fluid that does not pass through the membrane to pass, between the spokes 84. The center ring 90 forms the first passageway 88 for flow of the fluid that passes through the membrane. Further the spokes 84 may include a hollow interior 85 that prevents deformation and/or wraping during molding processes.

The seal plate 10 also serves as an anti-telescoping device and the anti-telescoping device serves to prevent the wound membrane from being released while maintaining the wound membrane state. If there is no anti-telescoping device, the membrane separation unit may not perform the function thereof.

However, holding two parts in the related art may cause a second part to be separated and be spaced apart from a first part of the anti-telescoping device, and as a result, rotation may occur between the membrane and the first part of the anti-telescoping device.

In particular, the anti-telescoping device is constituted by one part unlike the related art and a configuration is simple to thereby reduce production cost. That is, the anti-telescoping device designed by one part may prevent various loss and damages which may be caused when maintaining two parts and decrease manufacturing cost to improve productivity.

While the invention has been shown and described with respect to the preferred embodiments, it will be understood by those skilled in the art that various changes and modifications may be made without departing from the spirit and scope of the invention as defined in the following claims.

What is claimed is:

1. A membrane separation unit comprising:
(a) a cartridge having an interior, an exterior, and a pair of ends;
(b) at least one membrane disposed within the cartridge;
(c) a seal plate including one or more outer grooves and sealing one end of the cartridge; and
(d) a sealing ring seated in the outer groove,
wherein a top cross-section of the sealing ring is symmetrically formed.

2. The membrane separation unit of claim 1, wherein a cross-section of the sealing ring includes a rounded interior surface and two flat lateral surfaces.

3. The membrane separation unit of claim 1, wherein the cross-section of the sealing ring includes two flat surfaces that meet at a tip along an external surface of the sealing ring and two flat surfaces are symmetric to each other.

4. The membrane separation unit of claim 1, wherein the sealing ring has a cross-sectional shape in which a circular venting path is formed between the sealing ring and the seal plate.

5. The membrane separation unit of claim 1, wherein:
the seal plate includes at least one ventilation hole, and
the ventilation hole forms a passagewaybetween the outer groove and the interior of the cartridge.

6. The membrane separation unit of claim 1, wherein the membrane disposed in the cartridge has a spiral configuration.

7. A membrane separation device comprising:
(a) a device housing having an inside surface; and
(b) a plurality of membrane separation units disposed in series in the device housing,
wherein each of the membrane separation units has the structure according to claim 1, wherein the plurality of membrane separation units is seated within the device housing, such that the sealing ring contacts the inside surface of the device housing to form a seal between the membrane separation units and the device housing.

8. The membrane separation device of claim 7, wherein the device housing is cylindrical.

9. A sealing ring for a membrane separation unit, comprising:
two flat surfaces that meet at a tip along an external surface,
wherein the two flat surfaces are symmetric to each other.

10. The sealing ring of claim 9, wherein the sealing ring has one or more grooves on one face thereof.

11. The sealing ring of claim 9, further comprising:
a rounded internal surface.

12. A seal plate for a membrane separation unit, comprising:
(a) a body part which at least two concentric passageways penetrate; and
(b) a disk part including a plurality of holes and a central passageway,
wherein two concentric passageways, a first passageway is formed by a center ring and a second passageway is formed between the center ring and an outer ring, the center ring and the outer ring are connected by one or more spokes, and the outer ring includes an outer groove to hold a sealing ring, and
the disk part is provided integrally with a rear face of the body part.

13. The seal plate of claim 12, wherein the central passageway is aligned with the first passageway of the body part and a plurality of holes is aligned with the second passageway.

14. The seal plate of claim 12, wherein the outer ring of the body part includes an inner annular lip.

15. The seal plate of claim 12, wherein the outer ring forms at least one ventilation hole formed between the outer groove and an inner surface of the outer ring.

16. The seal plate of claim 12, wherein one or more spokes include a hollow interior.
